(19) United States
(12) Patent Application Publication
(10) Pub. No.: US 2008/0156576 A1
(43) Pub. Date: Jul. 3, 2008

(54) Process for Producing Loudspeaker Diaphragm, Loudspeaker Diaphragm Produced by the Process, and Louspeaker with the Diaphragm

(75) Inventors: Takashi Suzuki, Mie (JP); Shinya Mizone, Mie (JP)

Correspondence Address: RATNERPRESTIA, P.O. BOX 980, VALLEY FORGE, PA, 19482, US

(73) Assignee: Matsushita Electric Industrial Co., Ltd., Osaka (JP)

(21) Appl. No.: 11/814,404

(22) PCT Filed: Jan. 23, 2006
(86) PCT No.: PCT/JP2006/300935

§ 371 Date: Jul. 20, 2007

(30) Foreign Application Priority Data
Mar. 22, 2005 (JP) 2005-080943

(51) Int. Cl. H04R 7/02; D21J 3/00

(52) U.S. Cl. 181/148; 162/218; 181/169

(57) ABSTRACT

In a process for producing a loudspeaker diaphragm, pulp is deposited on a paper-making mold in the presence of vortex stream of water having pulp dispersed therein in a paper-making bath. Pulp is deposited on the paper-making mold while at least the water having pulp dispersed therein is rotated by the vortex stream in the paper-making bath. Consequently, variation of pulp fiber orientation is suppressed, and a loudspeaker diaphragm with high reproducibility and stable quality is produced with a high productivity.

### TECHNICAL FIELD

The present invention relates to a process for producing a loudspeaker diaphragm used for various audio apparatuses, a loudspeaker diaphragm produced by the process, and a loudspeaker with the diaphragm.

### BACKGROUND ART

A conventional technology will be described with reference to FIG. 5 and FIG. 6.

FIG. 5 is a side sectional view of a conventional loudspeaker, and FIG. 6 is a schematic block diagram of a paper-making device of a loudspeaker diaphragm as an essential part of the loudspeaker.

The conventional loudspeaker has magnetic circuit 1, frame 2, conical loudspeaker diaphragm 3, voice coil 4, and damper 5. Magnetic circuit 1 is formed by bonding lower plate 1a having a center pole, annular magnet 1b, and upper plate 1c superimposed on magnet 1b. Magnetic gap 1d is formed between the outer periphery of the center pole and the inner periphery of upper plate 1c. Frame 2 is bonded to upper plate 1c. The outer periphery of loudspeaker diaphragm 3 is bonded to frame 2 via edge 3a, and the lower part of the inner periphery thereof is bonded to voice coil 4 engaged with magnetic gap 1d. Damper 5 for supporting voice coil 4 vertically movably is bonded to voice coil 4 on its inner periphery, and is bonded to frame 2 on its outer periphery.

In the loudspeaker having the above-mentioned configuration, a voice signal is input as an external signal into voice coil 4, thereby moving loudspeaker diaphragm 3 vertically to produce a sound.

The loudspeaker diaphragm is made of paper, resin, or metal foil. Paper having undergone paper-making is generally used as the loudspeaker diaphragm in consideration of the following parameters:
physical properties such as magnitudes of internal loss and rigidity that are essentially required of a loudspeaker diaphragm;
cost; and
good sound making ability with a blend of various wood pulp as materials thereof.

FIG. 6 shows a producing process of loudspeaker diaphragm 3 formed by the paper-making. The paper-making device shown in FIG. 6 has the following elements: (1) paper-making bath 11 for supplying water having beaten pulp dispersed therein to an after-mentioned paper-making mold, (2) paper-making mold 12 formed of a wire mesh or the like, (3) measuring bath 13 for water having pulp dispersed therein, (4) supply pipe 14, (5) valve 15 for opening and closing a flow channel, (6) drainage pipe 16, and (7) valve 17 for opening and closing a drainage channel.

In a paper-making process using the paper-making device, water where pulp controlled in concentration is dispersed is firstly measured in measuring bath 13, and flow channel opening/closing valve 15 is then opened or closed to supply the pulp to paper-making bath 11 through supply pipe 14.

Thus, the pulp dispersed in a certain amount of water is supplied into paper-making bath 11, and gradually starts to be deposited onto paper-making mold 12 of paper-making bath 11. For performing this process in a short time, generally, the water is rapidly discharged from drainage pipe 16. This process is called as “suki-otoshi” paper-making method. At this time, random vortex occurs near the drainage port in the paper-making bath, and the pulp is deposited on paper-making mold 12 in random stream that can be caused by the random vortex in paper-making bath 11. The deposit is extracted and dried, a center hole is punched, and the outer periphery is removed, thereby providing a loudspeaker diaphragm.

There is another paper-making process in which water having a large amount of pulp dispersed therein is supplied into the paper-making bath, a wire cloth is put into the water having pulp dispersed therein in the paper-making bath, and the wire cloth is raised from the water. This process is called as “suki-age” paper-making method.

The conventional loudspeaker diaphragm and its producing process are disclosed in Japanese Patent Unexamined Publication No. 2003-230197, for example.

The loudspeaker diaphragm employing pulp is inexpensive, allows blending of various pulps, and easily provides a desired acoustic characteristic. However, there are the following difficulties in managing the loudspeaker diaphragm. Random stream in the paper-making bath in the paper-making process causes variation of deposition on pulp paper-making mold 12 and variation of pulp fiber orientation, or large variation of face thickness and face rigidity occurs even on the same circumference in the same diaphragm. As the performance of digital acoustic apparatuses has been recently increased by their development, higher reproducibility has been required of loudspeaker diaphragms.

### SUMMARY OF THE INVENTION

The present invention provides a process for producing a loudspeaker diaphragm that has a step of depositing pulp on a paper-making mold in the presence of vortex stream of water having pulp dispersed therein in a paper-making bath. The pulp is deposited on the paper-making mold while the water having pulp dispersed therein is rotated by vortex stream in the paper-making bath. Consequently, variation of pulp fiber orientation can be suppressed, and a loudspeaker diaphragm with high reproducibility and stable quality can be produced with a high productivity.

A loudspeaker diaphragm of the present invention is produced using the above-mentioned process for producing the loudspeaker diaphragm. A loudspeaker diaphragm having stable face thickness and face rigidity and high reproducibility can be produced with a high productivity.

A loudspeaker of the present invention employs the loudspeaker diaphragm, and a loudspeaker having small variation of acoustic characteristic and high reproducibility can be produced.

### BRIEF DESCRIPTION OF DRAWINGS

FIG. 1 is a schematic block diagram of a paper-making bath in a producing process of a loudspeaker diaphragm in accordance with an exemplary embodiment of the present invention.

FIG. 2 is a schematic block diagram of a paper-making bath in a producing process of a loudspeaker diaphragm in accordance with another exemplary embodiment of the present invention.

FIG. 3 is a schematic block diagram of a paper-making bath in a producing process of a loudspeaker diaphragm in accordance with another exemplary embodiment of the present invention.

FIG. 4 is a frequency sound pressure characteristic diagram of a loudspeaker employing a loudspeaker diaphragm produced by the producing process of the loudspeaker diaphragm of the present invention

FIG. 5 is a side sectional view of a conventional loudspeaker.

FIG. 6 is a schematic block diagram of a paper-making bath as an essential part of a producing process of a conventional loudspeaker diaphragm.

### REFERENCE MARKS IN THE DRAWINGS

1 magnetic circuit
1a lower plate
1b magnet
1c upper plate
1d magnetic gap
2 frame
3 loudspeaker diaphragm
3a edge
4 voice coil
5 damper
11 paper-making bath
12 paper-making mold
13 measuring bath
14 supply pipe
15 opening/closing valve
16 drainage pipe
17 opening/closing valve
21 paper-making bath
22 paper-making mold
23 measuring bath
24 supply pipe
25 opening/closing valve
26 drainage pipe
27 opening/closing valve
28 pressurized water nozzle
29 opening/closing valve
30a, 30b rotation plates
30c attaching shaft

### DETAILED DESCRIPTION OF PREFERRED EMBODIMENTS

In a producing process of a loudspeaker diaphragm of the present invention, water having beaten pulp dispersed therein is deposited on a paper-making mold in a paper-making bath while vortex stream is generated forcibly, thereby producing the loudspeaker diaphragm. Pulp is deposited on the paper-making mold while at least the whole water having the pulp dispersed therein in the paper-making bath is uniformly rotated by vortex stream, so that the variation of pulp fiber orientation can be suppressed. Thus, a loudspeaker diaphragm with high reproducibility and stable quality can be produced with a high productivity.

In a producing process of a loudspeaker diaphragm of the present invention, pressurized water may be sprayed to water having pulp dispersed therein, and vortex stream may be generated forcibly. The spray of the pressurized water allows extremely easy generation of vortex stream with which pulp fiber is oriented in a constant direction. Thus, a loudspeaker diaphragm having stable face thickness and face rigidity on the same circumference in the same diaphragm can be produced. A plurality of kinds of pressurized water may be sprayed to water having pulp dispersed therein to generate vortex stream. The spray of the plurality of kinds of pressurized water allows enlargement of the paper-making bath, further facilitates the generation and control of the vortex stream, and can improve productivity.

In a producing process of a loudspeaker diaphragm of the present invention, pressurized air may be sprayed to generate vortex stream. Since the vortex stream is generated by spray of the pressurized air, the vortex stream can be generated without varying the state of the water having pulp dispersed therein in the paper-making bath and the reproducibility in paper-making can be improved, comparing with the case of spraying the pressurized water.

In a producing process of a loudspeaker diaphragm of the present invention, a rotation plate may be lowered into the paper-making bath, and the rotation plate may be rotated to generate vortex stream. The rotation of the rotation plate easily generates vortex stream, and easily orients the pulp fiber in a specific direction.

In a producing process of a loudspeaker diaphragm of the present invention, a rotation plate previously installed in the paper-making bath may be rotated to generate vortex stream. The installation of the rotation plate in the paper-making bath allows downsizing of the paper-making bath. Providing a plurality of rotation plates facilitates the generation of vortex stream and control of vortex.

A loudspeaker diaphragm using a producing process of a loudspeaker diaphragm of the present invention has stable face thickness and stable face rigidity. Therefore, a loudspeaker diaphragm with high reproducibility can be provided with a high productivity.

A loudspeaker employing the loudspeaker diaphragm of the present invention has small variation of acoustic characteristic and high reproducibility.

In a producing process of a loudspeaker diaphragm of the present invention, by forcibly generating vortex stream in water having pulp dispersed therein in the paper-making bath, pulp can be deposited on the paper-making mold while a constant amount of stable vortex stream is kept in the water having pulp dispersed therein. The above producing process can provide a loudspeaker diaphragm in which uniformity of the pulp fiber orientation, no variation of face thickness and face rigidity on the same circumference in the same diaphragm, high reproducibility, and stable quality are attained.

Exemplary embodiments of the present invention will be hereinafter described further specifically.

### FIRST EXEMPLARY EMBODIMENT

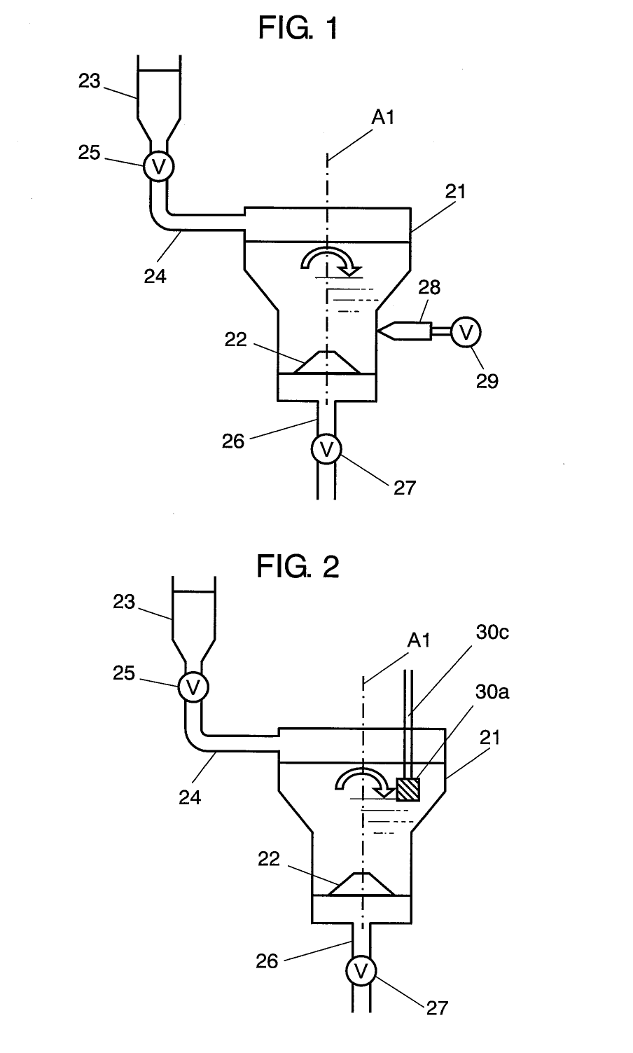

A production unit of a loudspeaker diaphragm used in the first exemplary embodiment is described with reference to FIG. 1.

The production unit of the first exemplary embodiment has the following elements: (1) paper-making bath 21 for supplying water having beaten pulp dispersed therein to paper-making mold 22, (2) paper-making mold 22 formed of a wire mesh or the like, (3) measuring bath 23 for water having pulp dispersed therein, (4) supply pipe 24, (5) valve 25 for opening and closing a flow channel, (6) drainage pipe 26, (7) valve 27 for opening and closing a drainage channel, (8) pressurized water nozzle 28 for generating vortex stream in the paper-making bath, and (9) valve 29 for opening and closing a flow channel of pressurized water.

Pressurized water opening/closing valve 29 is opened, thereby spraying pressurized water from the tip of pressurized water nozzle 28 to water having pulp dispersed therein in paper-making bath 21 for a certain time. By spraying the pressurized water, the water having pulp dispersed therein in paper-making bath 21 generates vortex stream as shown by the arrow of FIG. 1, for example. Also after closing pressurized water opening/closing valve 29, the water having pulp dispersed therein can keep a certain vortex stream due to the inertia for a certain time. Drainage channel opening/closing valve 27 is opened within a time when the vortex stream is kept, and the drainage from paper-making bath 21 through drainage pipe 26 is started.

The spray direction of the pressurized water is simply required to be a direction in which the water in paper-making bath 21 rotates about center axis A1. Therefore, the spray is preferably performed in a direction shifted from the direction heading for center axis A1 of paper-making bath 21. More preferably, the spray is performed in a direction substantially orthogonal to center axis A1 (that is, tangential direction to a circle around center axis A1). Preferably, the shape of the inner periphery of paper-making bath 21 does not disturb swirling and rotation of water, and the inner peripheral shape of a cylinder is appropriate, for example. Center axis A1 preferably matches with center axis A1 of paper-making mold 22.

In the above steps, the water having pulp dispersed therein is discharged from paper-making bath 21 while the certain vortex stream is kept in paper-making bath 21. As a result, a loudspeaker diaphragm is produced where pulp fiber is oriented in the constant direction on paper-making mold 22 in paper-making bath 21. The obtained loudspeaker diaphragm has pulp fiber that is oriented substantially axisymmetrically with respect to center axis A1. The loudspeaker diaphragm produced in this manner has stable face thickness and stable face rigidity on the same circumference in the same diaphragm.

An example where one pressurized water nozzle 28 is installed is described in the first exemplary embodiment; however, a plurality of pressurized water nozzles 28 may be installed. Installing the plurality of pressurized water nozzles 28 in paper-making bath 21 can generate stabler vortex stream in the water having pulp dispersed therein in a short time, and allows efficient production of a loudspeaker diaphragm with stabler physical properties. In this case, pressurized water nozzles 28 are arranged so that pressurized waters sprayed from pressurized water nozzles 28 do not cancel each other. Therefore, though all of pressurized water nozzles 28 are not required to be installed at the same angle, preferably, all of pressurized water nozzles 28 point to a desired rotation direction of the water.

A pressurized air nozzle may be disposed instead of pressurized water nozzle 28 of the first exemplary embodiment, and may generate vortex stream with the pressurized air. Additionally, a plurality of pressurized air nozzles are disposed, thereby generating stable vortex stream in a short time similarly to the case employing pressurized water, simplifying the facility structure, and building the facility inexpensively.

### SECOND EXEMPLARY EMBODIMENT

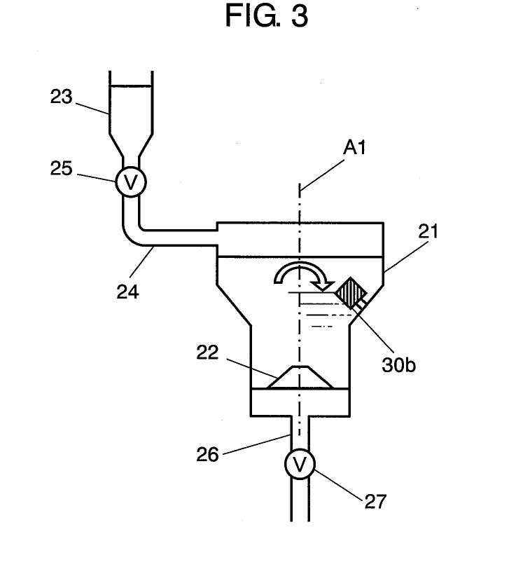

A producing process of a loudspeaker diaphragm of another exemplary embodiment of the present invention is described with reference to FIG. 2 and FIG. 3. FIG. 2 and FIG. 3 are schematic diagrams of paper-making baths as essential parts of production units.

The production unit of the loudspeaker diaphragm of FIG. 2 has rotation plate 30a disposed outside paper-making bath 21. Rotation plate 30a fixed to attaching shaft 30c is lowered from the outside of paper-making bath 21 into water having pulp dispersed therein in paper-making bath 21. Rotation plate 30a placed in the water is rotated, thereby generating vortex stream in the water having pulp dispersed therein. Once vortex stream occurs, the water having pulp dispersed therein can keep a certain vortex stream due to the inertia for a certain time even after rotation plate 30a is raised out of the paper-making bath.

Subsequent steps are the same as in the first exemplary embodiment, and the description of the steps is omitted.

When the water having pulp dispersed therein is mechanically rotated using rotation plate 30a, vortex stream can be more certainly generated than when the vortex stream is generated with pressurized water or pressurized air. The water in paper-making bath 21 is simply required to rotate about rotation axis A1, and a method of rotating rotation plate 30a is not especially limited. For example, rotation plate 30a and attaching shaft 30c may be integrally rotated about center axis A1. In this case, rotation plate 30a and attaching shaft 30c are used as a rotating means.

Rotation plate 30a is disposed on rotation axis A1, and only rotation plate 30a may be rotated at this position. Rotation plate 30a is disposed at a position out of rotation axis A1, and only rotation plate 30a may be rotated at this position. In these cases, rotation plate 30a is used as a rotating means. Rotation plate 30a and attaching shaft 30c may be rotated as a rotating means on the axis. The shape and rotation speed of rotation plate 30a are not especially limited as long as water in paper-making bath 21 rotates about rotation axis A1.

FIG. 3 shows another example of the second exemplary embodiment. In the production unit of the loudspeaker diaphragm of FIG. 3, rotation plate 30b used as a rotating means is previously installed in paper-making bath 21. Rotating rotation plate 30b can generate vortex stream in the water having pulp dispersed therein in paper-making bath 21. At this time, when rotation plate 30b is stopped in paper-making bath 21, the generated vortex stream in the water having pulp dispersed therein also stops. Therefore, drainage channel opening/closing valve 27 is opened while rotation plate 30b is kept rotating, and the drainage from paper-making bath 21 through drainage pipe 26 is started.

In the production unit of the loudspeaker diaphragm of FIG. 3, rotation plate 30b in paper-making bath 21 is kept rotating during the drainage, so that the vortex stream generated in the water having pulp dispersed therein can be kept in a stabler state.

In the second exemplary embodiment, examples having one of rotation plates 30a and 30b have been described. Since installation of a plurality of rotation plates 30a or a plurality of rotation plates 30b allows stable vortex stream to be generated in a short time, a loudspeaker diaphragm with stabler physical properties can be produced efficiently.

Table 1 shows measured tensile strengths of diaphragms that are produced by a conventional producing process without vortex stream and diaphragms that are paper-made by a producing process employing a paper-making bath having vortex stream of the first exemplary embodiment.

TABLE 1

| | | Loudspeaker |
|---|---|---|
| | Conventional | diaphragms of first |
| | diaphragms | exemplary embodiment |
| 1 | 0.205 | 0.310 |
| 2 | 0.167 | 0.369 |
| 3 | 0.191 | 0.324 |
| 4 | 0.157 | 0.325 |
| Ave. | 0.1798 | 0.3321 |
| MAX. | 0.205 | 0.369 |
| MIN. | 0.157 | 0.310 |
| R | 0.048 | 0.060 |
| σ | 0.022 | 0.026 |

unit: kN

Table 2 shows measured face thicknesses of diaphragms that are produced by the conventional producing process and diaphragms that are produced by the producing process of the first exemplary embodiment.

TABLE 2

| | Conventional | | Loudspeaker diaphragms of | |
|---|---|---|---|---|
| | diaphragms | | first exemplary embodiment | |
| | Inner | Outer | Inner | Outer |
| | peripheral | peripheral | peripheral | peripheral |
| | side | side | side | side |
| 1 | 0.25 | 0.25 | 0.28 | 0.30 |
| 2 | 0.29 | 0.27 | 0.29 | 0.31 |
| 3 | 0.30 | 0.29 | 0.30 | 0.29 |
| 4 | 0.26 | 0.30 | 0.29 | 0.30 |
| Ave. | 0.2750 | 0.2775 | 0.2900 | 0.3000 |
| MAX. | 0.300 | 0.300 | 0.300 | 0.310 |
| MIN. | 0.250 | 0.250 | 0.280 | 0.290 |
| R | 0.050 | 0.050 | 0.020 | 0.020 |
| σ | 0.024 | 0.022 | 0.008 | 0.008 |

unit: mm

As is clear from Table 1 and Table 2, the tensile strengths of the loudspeaker diaphragms of the first exemplary embodiment are higher than those of the conventional loudspeaker diaphragms. The face thicknesses of the loudspeaker diaphragms of the first exemplary embodiment are more uniform than those of the conventional loudspeaker diaphragms.

Table 1 and Table 2 show measurement results of four diaphragm samples 1, 2, 3 and 4, namely characteristic values of each diaphragm, the average values, maximum values, minimum values, differences R between the maximum values and minimum values, and deviations σ thereof.

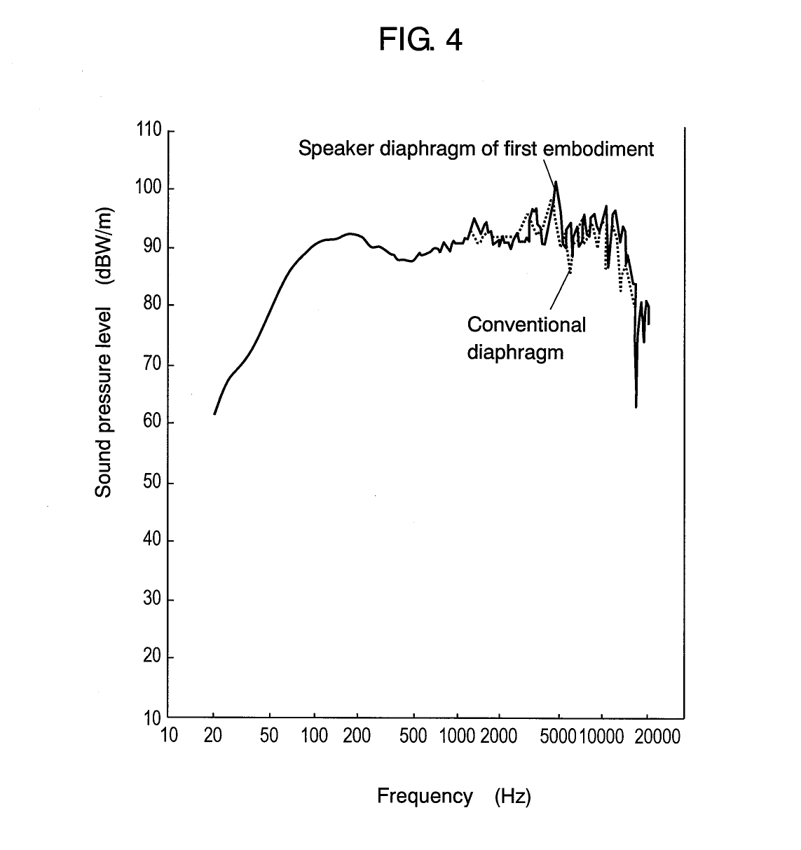

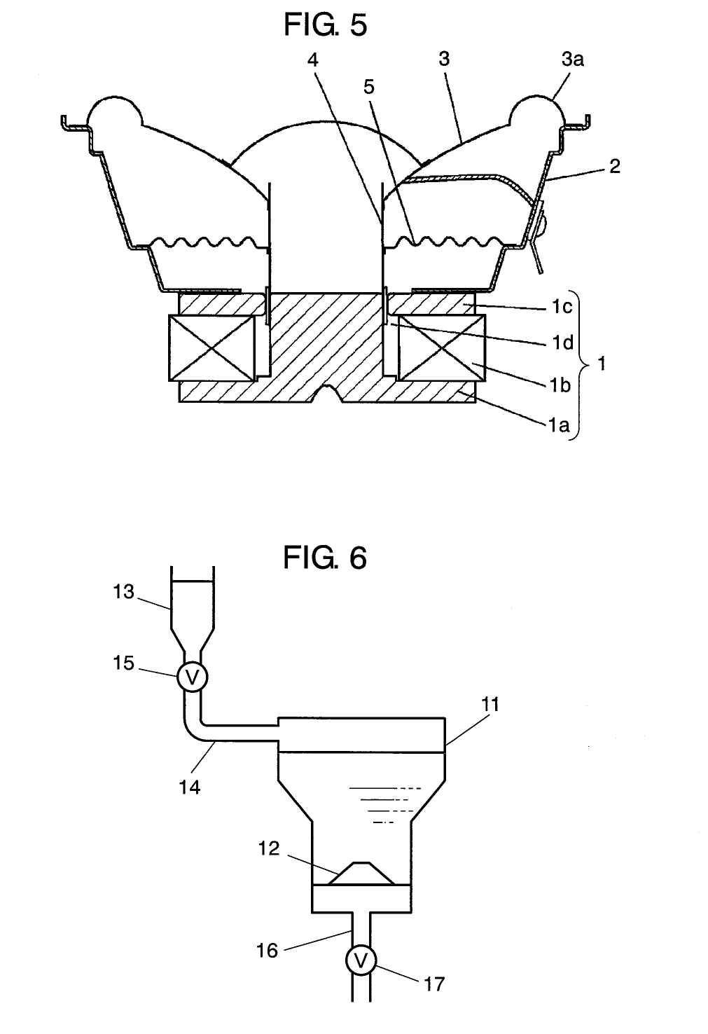

FIG. 4 shows measured frequency sound pressure characteristics of a loudspeaker that employs a loudspeaker diaphragm produced by the conventional producing process and a loudspeaker that employs a loudspeaker diaphragm produced by the producing process of the first exemplary embodiment. The configuration except the loudspeaker diaphragm of the loudspeaker of the first exemplary embodiment is the same as that of the conventional loudspeaker.

According to FIG. 4, the loudspeaker employing the loudspeaker diaphragm of the first exemplary embodiment of the present invention has an improved frequency-sound pressure characteristic in intermediate and high frequency region compared with the conventional loudspeaker that employs a loudspeaker diaphragm produced by the conventional producing process.

### INDUSTRIAL APPLICABILITY

A loudspeaker diaphragm of the present invention allows stable production of products where the pulp fiber orientation is uniform and the face thickness and face rigidity are uniform on the same circumference in the same diaphragm. This loudspeaker diaphragm is useful for a digital acoustic apparatus.

1. A process for producing a loudspeaker diaphragm comprising:
depositing pulp on a paper-making mold in the presence of vortex stream of water in a paper-making bath, the pulp being dispersed in the water.

2. The process for producing a loudspeaker diaphragm of claim 1, wherein the vortex stream is formed by spraying pressurized water to the water dispersing the pulp in the paper-making bath.

3. The process for producing a loudspeaker diaphragm of claim 2, wherein the pressurized water is sprayed from one or more nozzles into the paper-making bath.

4. The process for producing a loudspeaker diaphragm of claim 1, wherein the vortex stream is formed by spraying pressurized air to the water dispersing the pulp.

5. The process for producing a loudspeaker diaphragm of claim 4, wherein the pressurized air is sprayed from one or more nozzles into the paper-making bath.

6. The process for producing a loudspeaker diaphragm of claim 1, wherein the vortex stream is formed by rotating one or more rotating means in the paper-making bath.

7. The process for producing a loudspeaker diaphragm of claim 1, wherein a center axis of the vortex stream matches with a center axis of the paper-making mold.

8. The process for producing a loudspeaker diaphragm of claim 1, wherein the step of depositing the pulp is a step of discharging the water in the paper-making bath in the presence of the vortex stream of the water dispersing the pulp.

9. A loudspeaker diaphragm comprising pulp fiber oriented axisymmetrically with respect to an axis passing the center of gravity of a loudspeaker.

10. The loudspeaker diaphragm of claim 9 produced using a process for producing a loudspeaker diaphragm comprising:
depositing pulp on a paper-making mold in the presence of vortex stream of water in a paper-making bath, the pulp being dispersed in the water.

11. A loudspeaker comprising:
a frame coupled to a magnetic circuit;
a loudspeaker diaphragm comprising pulp fiber oriented axisymmetrically with respect to an axis passing the center of gravity of a loudspeaker; and
a voice coil coupled to the loudspeaker diaphragm, one end of the voice coil being inserted into a magnetic gap of the magnetic circuit.

12. A loudspeaker comprising:
a frame coupled to a magnetic circuit;
a loudspeaker diaphragm coupled to an outer periphery of the frame and produced using a process for producing a loudspeaker diaphragm comprising:
depositing pulp on a paper-making mold in the presence of vortex stream of water in a paper-making bath, the pulp being dispersed in the water; and
a voice coil coupled to the loudspeaker diaphragm, one end of the voice coil being inserted into a magnetic gap of the magnetic circuit.
